(19) United States
(12) Patent Application Publication
(10) Pub. No.: US 2026/0092818 A1
(43) Pub. Date: Apr. 2, 2026

(54) TEMPERATURE SENSOR

(71) Applicant: YAZAKI CORPORATION, Tokyo (JP)

(72) Inventors: Keisuke YAMAUCHI, Shizuoka (JP); Tadashi Ogawa, Shizuoka (JP)

(73) Assignee: YAZAKI CORPORATION, Tokyo (JP)

(21) Appl. No.: 19/343,985

(22) Filed: Sep. 29, 2025

(30) Foreign Application Priority Data
Sep. 30, 2024 (JP) 2024-170455

(51) Int. Cl. G01K 1/08; G01K 7/22; G01K 13/02

(52) U.S. Cl. CPC G01K 1/08; G01K 7/22; G01K 13/026

(57) ABSTRACT

A temperature sensor includes a temperature measuring element, an accommodating body in which the temperature measuring element is embedded and accommodated, and a housing having a storage space in which the accommodating body is stored. The housing includes a first housing including a concave portion therein that defines the storage space and having outside a temperature measuring surface that comes into contact with an object to be measured, a second housing assembled to the first housing and closing an opening of the concave portion, and a filler with which the storage space is filled and a gap between the accommodating body and the first housing is filled. A material constituting the second housing has heat transfer property lower than that of a material constituting the filler.

### CROSS-REFERENCE TO RELATED APPLICATIONS

This application is based on and claims priority under 35 USC 119 from Japanese Patent Application No. 2024-170455 filed on Sep. 30, 2024, the entire content of which is incorporated herein by reference.

### TECHNICAL FIELD

The present disclosure relates to a temperature sensor in which a temperature measuring element is stored.

### BACKGROUND ART

In the related art, temperature sensors for measuring temperatures of various objects to be measured (for example, a gas and a liquid) have been proposed. For example, one of the temperature sensors in the related art has a built-in thermistor for temperature measurement, and is attached to an in-vehicle pipe to measure a temperature of a fluid flowing in the in-vehicle pipe (for example, see Patent Literature 1).

### CITATION LIST

### Patent Literature

Patent Literature 1: JP H02-245626A

### SUMMARY OF INVENTION

In the temperature sensor in the related art, a protective tube in which one opening portion is closed is filled with a protective resin, and all of a thermistor, a lead wire extending from the thermistor, and a contact point between the lead wire and an external electric wire are embedded in the protective resin. When the temperature sensor is actually used, heat transferred from a fluid to be measured to the protective tube is transferred to the thermistor through the protective resin. More specifically, the heat received by the protective resin increases a temperature of the protective resin itself while being diffused into the protective resin, and the heat is transferred from the heated protective resin to the thermistor. In consideration of such a heat transfer principle, it is considered that in the temperature sensor in the related art, the heat transferred from the protective tube to the protective resin is diffused over the entire protective resin that occupies most of a structure of the temperature sensor, and as a result, it is difficult to improve the response performance of the temperature sensor.

One object of the present disclosure is to provide a temperature sensor with excellent response performance.

In order to achieve the above object, the temperature sensor according to the present disclosure is characterized as follows.

A temperature sensor includes: a temperature measuring element; an accommodating body in which the temperature measuring element is embedded and accommodated; and a housing having a storage space in which the accommodating body is stored. The housing includes a first housing including a concave portion therein that defines the storage space and having outside a temperature measuring surface that comes into contact with an object to be measured, a second housing assembled to the first housing and closing an opening of the concave portion, and a filler with which the storage space is filled and a gap between the accommodating body and the first housing is filled. A material constituting the second housing has heat transfer property lower than that of a material constituting the filler.

According to the temperature sensor of the present disclosure, the concave portion of the first housing defines the storage space, the accommodating body in which the temperature measuring element is accommodated is stored in the storage space, the second housing closes the opening of the storage space, and the gap within the storage space is filled with the filler. Here, the material constituting the second housing has the heat transfer property lower than that of the material constituting the filler. Typical quantities related to the heat transfer of the material include thermal conductivity, thermal diffusivity, and specific heat capacity. Of these, the level of “heat transfer property” in the present disclosure can also be rephrased as the level of thermal conductivity. In the temperature sensor of this configuration, the second housing has relatively low heat transfer property, and thus the heat is less likely to be transmitted at the boundary between the second housing and the filler than if there is no difference in the heat transfer property between the second housing and the filler. In other words, the heat is less likely to be released from the filler to the second housing. Therefore, the temperature of the filler itself is rapidly increased by the heat transmitted from the first housing to the filler, and the temperature measuring element can quickly detect the temperature change. Therefore, the temperature sensor of the present disclosure is excellent in response performance as compared with the temperature sensor in the related art.

The present disclosure is briefly described above. Further, details of the present disclosure will be clarified by reading modes for carrying out the disclosure described below with reference to the accompanying drawings.

### BRIEF DESCRIPTION OF DRAWINGS

FIG. 1 is a perspective view illustrating a temperature sensor according to an embodiment of the present disclosure;

FIG. 2 is a cross-sectional view corresponding to a cross section taken along a line A-A of FIG. 1, for explaining a state in which the temperature sensor illustrated in FIG. 1 is attached to an attachment hole of an attachment object;

FIG. 3 is an enlarged view of a portion B in FIG. 2;

FIG. 4 is a side view illustrating an assembly procedure of the temperature sensor illustrated in FIG. 1;

FIG. 5 is a cross-sectional view taken along a line C-C in FIG. 4; and

FIG. 6 is a side view (partial cross-sectional view) illustrating a state in which an insertion portion of a resin housing is inserted in an inclined manner with respect to a concave portion of a metal casing in a process of assembling the temperature sensor illustrated in FIG. 1.

### DESCRIPTION OF EMBODIMENTS

### Embodiment

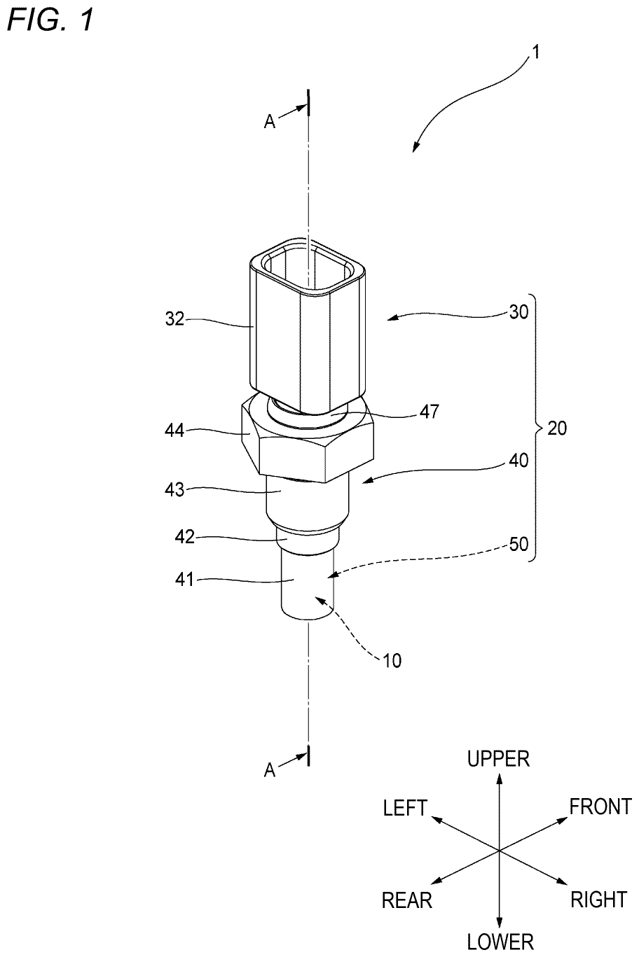

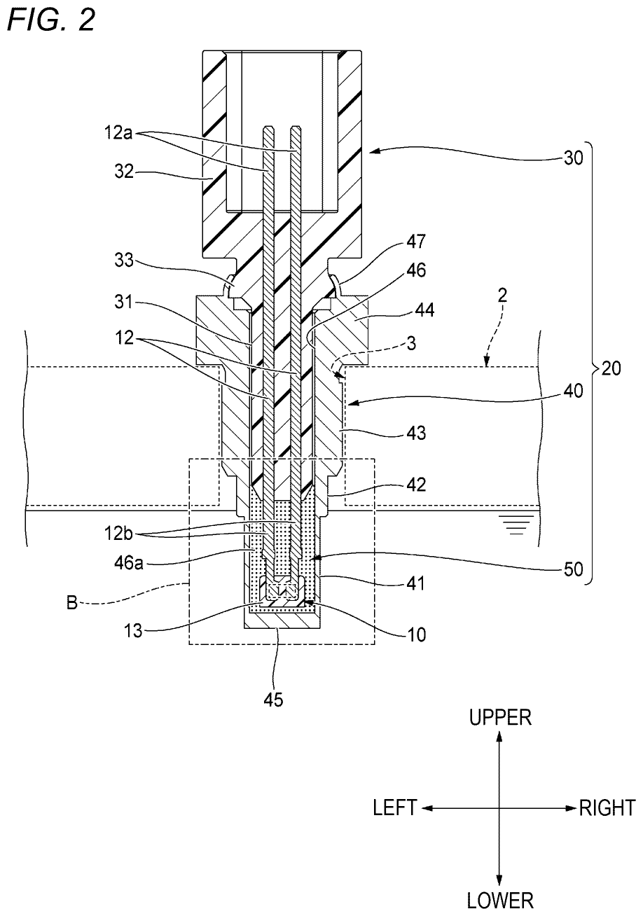

Hereinafter, a temperature sensor 1 according to an embodiment of the present disclosure will be described with reference to the drawings. As illustrated in FIG. 2, the temperature sensor 1 illustrated in FIG. 1 is used in a state of being inserted into and fixed to an attachment hole 3 of an attachment object 2. The attachment object 2 is, for example, a wall of a device in which a flow path of cooling water in a vehicle is built, and in this case, the temperature sensor 1 attached to the attachment object functions to measure a temperature of the cooling water in the device. The temperature sensor 1 includes a thermistor 10 and a housing 20 that stores the thermistor 10 therein.

Hereinafter, for convenience of description, “front”, “rear”, “left”, “right”, “upper”, and “lower” are defined as illustrated in FIG. 1 and the like. A “front-rear direction”, a “left-right direction”, and an “upper-lower direction” are orthogonal to one another. The front-rear direction, the left-right direction, and the upper-lower direction do not necessarily have to coincide with a front-rear direction, a left-right direction, and an upper-lower direction of the vehicle or the like on which the temperature sensor 1 is mounted. Hereinafter, the components constituting the temperature sensor 1 will be described in order.

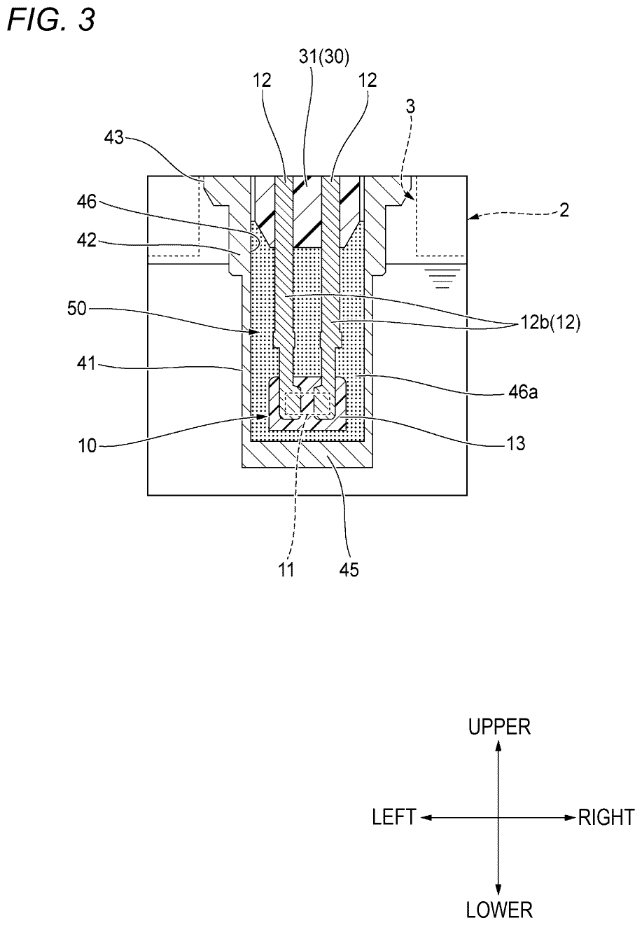

First, the thermistor 10 will be described. As illustrated in FIGS. 2 and 3 and the like, the thermistor 10 includes a thermistor element 11, a pair of rod-shaped metal terminals 12 extending upward from the thermistor element 11, and a resin accommodating body 13 that accommodates the thermistor element 11 such that the entire thermistor element 11 is embedded therein. The accommodating body 13 is, for example, a molded body (primary molded body) made of an epoxy resin. The thermistor element 11 is integrated with the accommodating body 13 by, for example, transfer molding (primary molding). The pair of terminals 12 linearly protrude upward from an upper face of the accommodating body 13 while facing each other with an interval in the left-right direction and are exposed to an outside of the accommodating body 13. Most of the pair of terminals 12 exposed to the outside of the accommodating body 13 are stored (embedded) inside a resin housing 30 and a filler 50 (to be described later) that constitute the housing 20 (see FIG. 2 and the like). In this example, the pair of terminals 12 have a linear shape, but the pair of terminals 12 may have a curved shape according to a shape of the resin housing 30 or the like.

The resin accommodating body 13 is a die-molded article having a substantially rectangular parallelepiped molded shape. In other words, the accommodating body 13 is molded using a die so as to have a previously designed molded shape. Accordingly, the variation in the shape of the accommodating body 13 is reduced. The accommodating body 13 has a substantially rectangular parallelepiped molded shape having an outer face constituted by six faces. In general, in the accommodating body having such a shape, when a work tool or the like is brought into contact with a boundary or the like between adjacent surfaces, there is a concern that deformation or the like of the accommodating body may occur due to stress concentration in the contact portion or the like. However, in the temperature sensor 1, the accommodating body 13 is stored inside the housing 20, and thus even though the accommodating body 13 has such a molded shape, the deformation or the like of the accommodating body 13 can be appropriately reduced.

Next, the housing 20 will be described. As illustrated in FIGS. 1 and 2 and the like, the housing 20 includes the resin housing 30, a metal casing 40, and the filler 50.

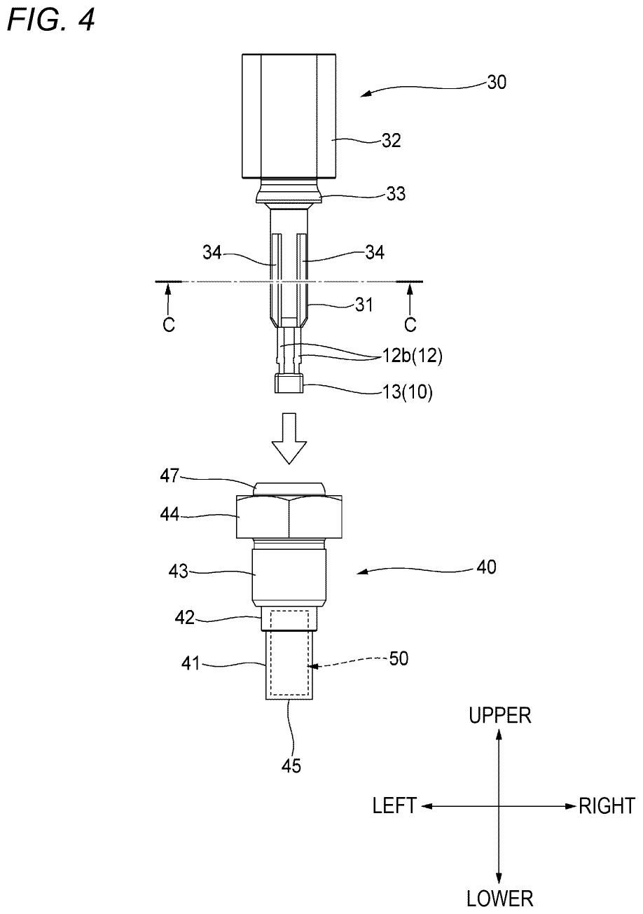

First, the resin housing 30 will be described. The resin housing 30 is, for example, a molded body (secondary molded body) made of, for example, a polyphenylene sulfide (PPS) resin. A resin material constituting the resin housing 30 has heat transfer property lower than that of a resin material constituting the accommodating body 13. As illustrated in FIG. 2 and the like, the resin housing 30 integrally includes a substantially elongated columnar insertion portion 31 extending in the upper-lower direction and a connector portion 32 located above the insertion portion 31 and having a substantially rectangular box-shaped hood shape extending so as to protrude upward, and has a shape that extends in the upper-lower direction as a whole. The insertion portion 31 is a portion to be inserted into the concave portion 46 of the metal casing 40 (to be described later) (see FIGS. 2 and 4 and the like). An upper end of the connector portion 32 is opened.

As illustrated in FIG. 2, the entire portion of the pair of terminals 12 extending upward from the accommodating body 13 (primary molded body), except for tip end portions 12a and base end portions 12b, is integrated and held in the resin housing 30 (insertion portion 31+connector portion 32). The tip end portions 12a of the pair of terminals 12 protrude upward from a rear wall (lower end wall) of the connector portion 32 in a hollow portion of the connector portion 32, and are exposed to an outside of the resin housing 30 through an upper end opening of the connector portion 32 (see FIG. 2 and the like). The base end portions 12b of the pair of terminals 12 protrude downward from a lower end of the insertion portion 31 and are exposed to the outside of the resin housing 30 between the accommodating body 13 (primary molded body) and the resin housing 30 (secondary molded body).

In this example, the pair of terminals 12 extending upward from the accommodating body 13 each have a simple straight shape, and thus, by inserting the pair of terminals 12 into a pair of through holes provided in the resin housing 30 after being molded, the entire portion of the pair of terminals 12, except for the tip end portions 12a and the base end portions 12b, can be held in the resin housing 30. In another manufacturing method, insert molding (secondary molding) may be performed such that the pair of terminals 12 are embedded in the resin housing 30. The former manufacturing method is advantageous in that a step of the insert molding (secondary molding) can be omitted. When the pair of terminals 12 are curved, the former manufacturing method is less likely to be applied, and thus the latter insert molding is performed.

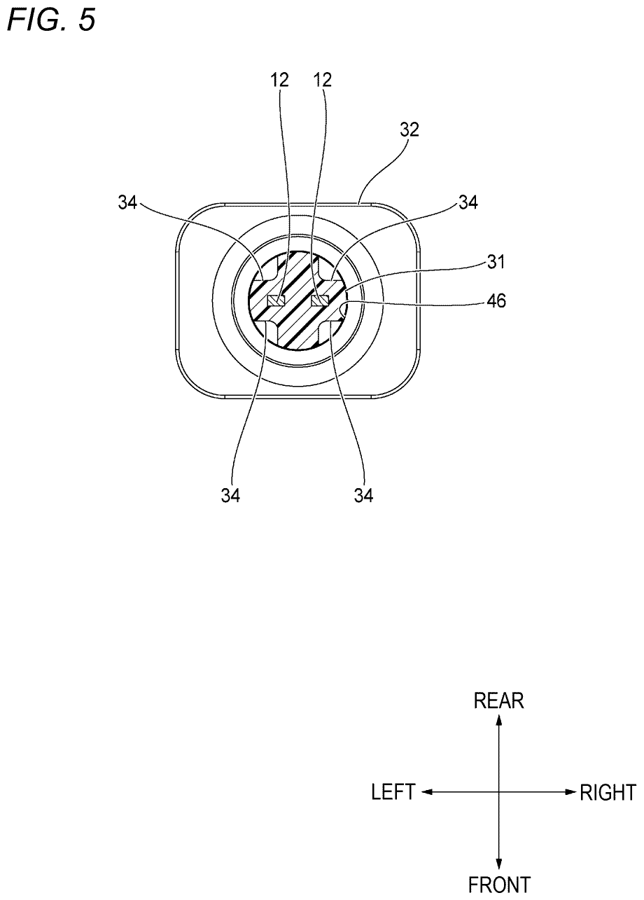

An outer face of a boundary portion between the insertion portion 31 and the connector portion 32 is provided with a circular ring-shaped protruding portion 33 protruding laterally over an entire region in a circumferential direction (see FIG. 2). A circular ring-shaped crimping piece 47 of the metal casing 40, which will be described later, is to be crimped and fixed to the circular ring-shaped protruding portion 33. At a plurality of locations (four locations in this example) in a circumferential direction of an outer peripheral face of the substantially elongated columnar insertion portion 31, groove portions 34 are formed, extending in the upper-lower direction from a lower end to an upper portion of the outer face (see FIGS. 4 and 5). Operations and effects of forming such groove portions 34 will be described later. As described above, the resin housing 30 holds the pair of terminals 12 (that is, the thermistor 10) in a state in which the tip end portions 12a and the base end portions 12b of the pair of terminals 12 and the accommodating body 13 are exposed to the outside of the resin housing 30.

Next, the metal casing 40 will be described. As illustrated in FIGS. 1 and 2 and the like, the metal casing 40 made of metal has a cylindrical shape extending in the upper-lower direction as a whole, and integrally includes a cylindrical small-diameter portion 41, a cylindrical middle-diameter portion 42 located above the small-diameter portion 41 and having an outer diameter larger than that of the small-diameter portion 41, a cylindrical large-diameter portion 43 located above the middle-diameter portion 42 and having an outer diameter larger than that of the middle-diameter portion 42, and a flange portion 44 located above the large-diameter portion 43 and having a hexagonal shape whose outer peripheral shape is larger than the large-diameter portion 43. The outer diameter of the large-diameter portion 43 is designed to be a value corresponding to an inner diameter of the attachment hole 3 of the attachment object 2 (value slightly smaller than the inner diameter) (see FIG. 2).

The metal casing 40 is formed therein with the elongated columnar concave portion 46 extending in the upper-lower direction over an entire region in the upper-lower direction of the metal casing 40. A lower end of the concave portion 46 (that is, a lower end of the small-diameter portion 41) is closed by a bottom wall 45, and an upper end of the concave portion 46 (that is, an upper end of the flange portion 44) is opened. An inner diameter of the concave portion 46 is designed to be a value corresponding to an outer diameter of the insertion portion 31 of the resin housing 30 (value slightly larger than the outer diameter) (see FIG. 2 and the like).

The circular ring-shaped crimping piece 47 protruding upward over an entire region in a circumferential direction so as to surround the upper end opening of the concave portion 46 is provided on an upper end face of the flange portion 44 (see FIGS. 1 and 2). Of the concave portion 46 extending in the upper-lower direction, a portion belonging to the small-diameter portion 41 (portion in the vicinity of the lower end of the concave portion 46 including the lower end) defines a storage space 46a (also see FIG. 3). The storage space 46a stores the accommodating body 13 of the thermistor 10 and is filled with the filler 50 (see FIG. 2 and the like). Here, the small-diameter portion 41 and the bottom wall 45 correspond to a “wall portion, one surface (outer faces) of which is a temperature measuring surface and the other surfaces (inner faces) of which face the storage space (46a)” of the present disclosure.

As illustrated in FIG. 4, the insertion portion 31 of the resin housing 30 is inserted into the concave portion 46 of the metal casing 40 in a state in which the filler 50 is injected. More specifically, first, the liquid filler 50 is injected into the concave portion 46 via the upper end opening of the concave portion 46 until at least the entire storage space 46a located in the portion in the vicinity of the lower end of the concave portion 46 is filled with the liquid filler 50. The filler 50 is made of, for example, epoxy resin.

Regarding the heat transfer property of the above materials, the PPS (material constituting the resin housing 30) used in this example has a thermal conductivity lower than that of the epoxy resin (material constituting the filler 50) used in this example.

Next, the insertion portion 31 of the resin housing 30 (and the accommodating body 13 coupled to the insertion portion 31 via the base end portions 12b of the pair of terminals 12) is inserted into the concave portion 46 via the upper end opening of the concave portion 46. In the process of inserting the insertion portion 31 into the concave portion 46, the filler 50 can be released to the groove portion 34 (see FIGS. 4 and 5) formed on the outer face of the insertion portion 31 while the accommodating body 13 and the base end portions 12b of the pair of terminals 12 are embedded in the filler 50. As a result, it is possible to prevent air bubbles or the like that affect the response performance of the temperature sensor 1 from remaining in the filler 50.

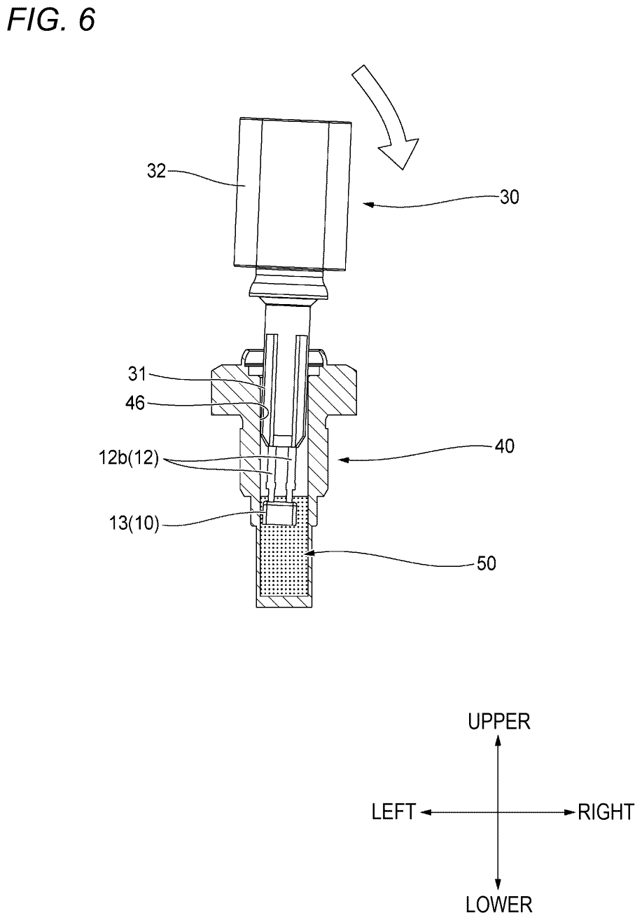

Further, in the process of inserting the insertion portion 31 into the concave portion 46, as indicated by a white arrow in FIG. 6, even when a moment in an inclination direction acts on the insertion portion 31 and the insertion portion 31 is inclined with respect to the concave portion 46, the insertion portion 31 comes into contact with an inner peripheral face of the concave portion 46 before the accommodating body 13 comes into contact with the inner peripheral face of the concave portion 46 due to a fact that a length in the upper-lower direction of the insertion portion 31 is long and a gap between the outer peripheral face of the insertion portion 31 and the inner peripheral face of the concave portion 46 is small. As a result, the deformation or the like of the accommodating body 13 caused by the accommodating body 13 coming into contact with the inner peripheral face of the concave portion 46 can be reduced.

In the state in which the insertion of the insertion portion 31 into the concave portion 46 is completed, as illustrated in FIGS. 2 and 3, the upper end opening of the concave portion 46 is closed by the insertion portion 31, the accommodating body 13 and the base end portion 12b of the pair of terminals 12 are entirely embedded in the filler 50, and a gap between outer faces of the accommodating body 13 and the base end portions 12b of the pair of terminals 12, and a lower end face of the insertion portion 31 of the resin housing 30, an inner wall face of the concave portion 46 of the metal casing 40, and an inner wall face of the bottom wall 45 is filled with the filler 50. The storage space 46a that stores the accommodating body 13 and is filled with the filler 50 is sealed by (insertion portion 31 of) the resin housing 30 having the heat transfer property lower than that of the filler 50. In addition, a liquid level of the filler 50 after the insertion of the insertion portion 31 is completed is increased by a volume of the accommodating body 13 and the base end portions 12b of the pair of terminals 12, which are embedded in the filler 50, as compared with before the insertion portion 31 is inserted. That is, in the insertion completion state of the insertion portion 31, not only an entire space (=the entire storage space 46a) defined by the portion of the concave portion 46 belonging to the small-diameter portion 41, but also a part or all of a space defined by a portion of the concave portion 46 belonging to the middle-diameter portion 42 is filled with the filler 50 (see FIGS. 2 and 3).

When the insertion of the insertion portion 31 into the concave portion 46 is completed, the circular ring-shaped crimping piece 47 of the metal casing 40 is crimped and fixed to the circular ring-shaped protruding portion 33 of the resin housing 30, whereby the resin housing 30 is fixed to the metal casing 40, and the filler 50 with which the concave portion 46 is filled is solidify by natural cooling. As described above, the housing 20 (see FIGS. 1 and 2) including the resin housing 30, the metal casing 40, and the filler 50 is completed, and the temperature sensor 1 illustrated in FIG. 1 is completed.

As illustrated in FIG. 2, the completed temperature sensor 1 is used in a state in which a portion of the metal casing 40 below the flange portion 44 is inserted into the attachment hole 3 of the attachment object 2 from above, and a counterpart connector (not illustrated) connected to a temperature detecting device (not illustrated) is fitted into the connector portion 32. In a state in which the insertion of the temperature sensor 1 (metal casing 40) into the attachment hole 3 is completed, the flange portion 44 is locked to an edge portion of the attachment hole 3, the large-diameter portion 43 is fitted into the attachment hole 3, the middle-diameter portion 42 is located in the attachment hole 3, and the small-diameter portion 41 protrudes from the attachment hole 3 and is located in the above flow path. At this time, the temperature sensor 1 is preferably disposed such that a liquid level of the cooling water in the flow path is located between the lower end of the insertion portion 31 and an upper end of the accommodating body 13. That is, the outer faces of the small-diameter portion 41 and the bottom wall 45 of the metal casing 40 constitute the “temperature measuring surface” that comes into contact with the cooling water (object to be measured) flowing through the flow path.

The heat of the cooling water (object to be measured) flowing through the flow path is transmitted to the filler 50 via the small-diameter portion 41 and the bottom wall 45, which have the outer faces constituting the “temperature measuring surface”. The heat transmitted to the filler 50 increases the temperature of the filler 50 (that is, the accommodating body 13 embedded in the filler 50) itself while being transmitted so as to spread in the filler 50. The thermistor element 11 embedded in the accommodating body 13 outputs an electrical signal representing a temperature around the thermistor element 11 (temperature of the accommodating body 13), and when the electrical signal is input to the temperature detecting device, the temperature around the thermistor element 11 (that is, the temperature of the object to be measured) is detected. Furthermore, the heat transferred to the filler 50 is not only transferred to the thermistor element 11 via the filler 50, but also transferred from the filler 50 to the thermistor element 11 via the terminals 12. Accordingly, the temperature around the thermistor element 11 is detected more quickly.

In the temperature sensor 1, the inner faces of the small-diameter portion 41 and the bottom wall 45, which have the outer faces constituting the “temperature measuring surface”, face the storage space 46a filled with the filler material 50. Therefore, the heat of the cooling water (object to be measured) flowing through the flow path is quickly transferred via the small-diameter portion 41 and the bottom wall 45 to the filler 50 with which the storage space 46a is filled. Further, as described above, the storage space 46a that stores the accommodating body 13 and is filled with the filler 50 is sealed by the insertion portion 31 of the resin housing 30 having the heat transfer property lower than that of the filler 50. Therefore, the heat transferred to the filler 50 can quickly increase the temperature of the filler 50 (that is, the accommodating body 13) itself. Furthermore, the outer faces of the base end portions 12b of the pair of terminals 12 connected to the thermistor element 11 are in direct contact with the filler 50. Therefore, the heat transferred to the filler 50 is easily transferred to the thermistor element 11 via the terminals 12 made of metal (that is, high heat transfer property). As a result, even when the temperature of the cooling water (object to be measured) flowing through the flow path suddenly changes, the thermistor element 11 in the accommodating body 13 can quickly detect the temperature change. In other words, the temperature sensor 1 has excellent response performance.

### Operations and Effects

As described above, according to the temperature sensor 1 according to the present embodiment, the second housing (resin housing 30) closes the opening of the concave portion 46 of the first housing (metal casing 40) that defines the storage space 46a, the storage space 46a stores the accommodating body 13 in which the temperature measuring element (thermistor element 11) is accommodated, and the gap within the storage space 46a is filled with the filler 50. Further, the material constituting the second housing 30 has the heat transfer property lower than that of the material constituting the filler 50. Accordingly, the storage space 46a is sealed by the second housing 30 having low heat transfer property, and thus the heat transferred from the first housing 40 to the filler 50 quickly increases the temperature of the filler 50 itself, and the temperature measuring element 11 in the accommodating body 13 can quickly detect the temperature. Therefore, the temperature sensor 1 according to the present embodiment has excellent response performance.

Further, the heat transferred from the first housing (the metal casing 40) to the filler 50 is not only transferred to the temperature measuring element (thermistor element 11) via the filler 50, but also transferred from the filler 50 to the temperature measuring element 11 via the terminals 12. The terminal 12 is made of metal, and usually has higher heat transfer property than the filler 50. Accordingly, the response performance of the temperature sensor 1 can be further improved.

Further, according to the temperature sensor 1 according to the present embodiment, the insertion portion 31 of the second housing 30 includes, on the outer face thereof, the groove portion 34 extending along the insertion direction into the concave portion 46. Accordingly, when the temperature sensor 1 is manufactured, the filler 50 is injected into the concave portion 46 of the first housing 40 in advance, and when the accommodating body 13 and the insertion portion 31 of the second housing 30 are inserted into the concave portion 46, the filler 50 can be released to the groove portion 34 of the insertion portion 31 while the accommodating body 13 is embedded in the filler 50. As a result, it is possible to prevent the air bubbles or the like that affect the response performance of the temperature sensor 1 from remaining in the filler 50. Therefore, the response performance of the temperature sensor 1 can be improved.

Further, according to the temperature sensor 1 according to the present embodiment, the one surface of the wall portion (small-diameter portion 41 and bottom wall 45) of the first housing 40 is the temperature measuring surface, and the other surfaces of the wall portions 41 and 45 face the storage space 46a. Accordingly, when the temperature sensor 1 is actually used, the heat can be quickly transferred from the object to be measured to the filler in the storage space 46a via the temperature measuring surface. Therefore, the response performance of the temperature sensor 1 can be improved.

Further, according to the temperature sensor 1 according to the present embodiment, the accommodating body 13 in which the temperature measuring element 11 is embedded is the die-molded article having a predetermined molded shape. In other words, the accommodating body 13 is not molded by using a fluidized-bed coating method in the related art, but is molded using a die designed to have a predetermined molded shape. Accordingly, the variation in the shape of the accommodating body 13 is reduced as compared with the prior art. Therefore, for example, the accommodating body 13 can be accurately formed so as to have a shape suitable for temperature measurement corresponding to a gas, a liquid, or the like to be measured. Therefore, the response performance of the temperature sensor 1 can be improved.

Furthermore, according to the temperature sensor 1 according to the present embodiment, the accommodating body 13 has a molded shape having an outer face constituted by a plurality of faces (six faces). In this case, for example, when the work tool or the like comes into contact with the boundary or the like between the adjacent surfaces, the stress concentration occurs in the contact portion, and thus the deformation or the like of the accommodating body 13 may occur. However, the accommodating body 13 is stored inside the housing 20, and thus even though the accommodating body 13 has such a molded shape, the deformation or the like of the accommodating body 13 can be appropriately reduced. Therefore, the temperature sensor 1 can exhibit temperature measurement performance as designed.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions and the like of components in the embodiments described above are freely selected and are not limited as long as the present disclosure can be implemented.

Here, features of the embodiment of the temperature sensor 1 according to the present disclosure described above are briefly summarized and listed in the following [1] to [6].

[1]

A temperature sensor (1) including: a temperature measuring element (11); an accommodating body (13) in which the temperature measuring element (11) is embedded and accommodated; and a housing (20) having a storage space (46a) in which the accommodating body (13) is stored, in which
the housing (20) includes a first housing (40) including a concave portion (46) therein that defines the storage space (46a) and having outside a temperature measuring surface that comes into contact with an object to be measured, a second housing (30) assembled to the first housing (40) and closing an opening of the concave portion (46), and a filler (50) with which the storage space (46a) is filled and a gap between the accommodating body (13) and the first housing (40) is filled, and
a material constituting the second housing (30) has heat transfer property lower than that of a material constituting the filler (50).

According to the temperature sensor having the configuration of [1], the concave portion of the first housing defines the storage space, the accommodating body in which the temperature measuring element is accommodated is stored in the storage space, the second housing closes the opening of the storage space, and the gap within the storage space is filled with the filler. Here, the material constituting the second housing has the heat transfer property lower than that of the material constituting the filler. Typical quantities related to the heat transfer of the material include thermal conductivity, thermal diffusivity, and specific heat capacity. Of these, the level of “heat transfer property” in the present disclosure can also be rephrased as the level of thermal conductivity. In the temperature sensor of this configuration, the second housing has relatively low heat transfer property, and thus the heat is less likely to be transmitted at the boundary between the second housing and the filler than if there is no difference in the heat transfer property between the second housing and the filler. In other words, the heat is less likely to be released from the filler to the second housing. Therefore, the temperature of the filler itself is rapidly increased by the heat transmitted from the first housing to the filler, and the temperature measuring element can quickly detect the temperature change. Therefore, the temperature sensor of this configuration is excellent in the response performance as compared with a temperature sensor in the related art.

[2]

The temperature sensor (1) according to [1], further including: a terminal (12) connected to the temperature measuring element (11) and extending from the accommodating body (13), in which
the terminal (12) is in contact with the filler (50).

According to the temperature sensor having the configuration of [2], the heat transferred from the first housing to the filler is not only transmitted to the temperature measuring element via the filler but also transmitted from the filler to the temperature measuring element via the terminal. The terminal is made of metal, and usually has higher heat transfer property than the filler. Accordingly, the response performance of the temperature sensor can be further improved.

[3]

The temperature sensor (1) according to [2], in which
the second housing (30) includes an insertion portion (31) that holds the terminal (12) and is inserted into the concave portion (46) to close the opening, and
the insertion portion (31) includes, on an outer face of the insertion portion (31), a groove portion (34) extending along an insertion direction into the concave portion (46).

According to the temperature sensor having the configuration of [3], the insertion portion of the second housing includes, on the outer face thereof, the groove portion extending along the insertion direction into the concave portion. Accordingly, when the temperature sensor is manufactured, the filler is injected into the concave portion of the first housing in advance, and when the accommodating body and the insertion portion of the second housing are inserted into the concave portion, the filler can be released to the groove portion of the insertion portion while the accommodating body is embedded in the filler. As a result, it is possible to prevent the air bubbles or the like that affect the response performance of the temperature sensor from remaining in the filler. Therefore, the response performance of the temperature sensor can be improved.

[4]

The temperature sensor (1) according to [1], in which
the first housing (40) includes a wall portion (41, 45) having one surface which is the temperature measuring surface and other surface which faces the storage space (46a).

According to the temperature sensor having the configuration of [4], the first housing includes the wall portion, one surface of which is the temperature measuring surface and the other surface of which faces the storage space. Accordingly, when the temperature sensor is actually used, the heat can be quickly transferred from the object to be measured to the filler in the storage space via the temperature measuring surface. Therefore, the response performance of the temperature sensor can be improved.

[5]

The temperature sensor (1) according to [1], in which
the accommodating body (13) is a die-molded article having a predetermined molded shape.

According to the temperature sensor having the configuration of [5], the accommodating body in which the temperature measuring element is embedded is the die-molded article having a predetermined molded shape. In other words, the accommodating body is not molded by using a fluidized-bed coating method in the related art, but is molded using a die designed to have the predetermined molded shape. Accordingly, the variation in the shape of the accommodating body is reduced as compared with the prior art. Therefore, for example, the accommodating body can be accurately formed so as to have a shape suitable for temperature measurement corresponding to a gas, a liquid, or the like to be measured. Therefore, the response performance of the temperature sensor can be improved.

[6]

The temperature sensor (1) according to [5], in which
the molded shape of the accommodating body (13) is a shape having an outer face constituted by a plurality of faces.

According to the temperature sensor having the configuration of [6], the accommodating body has a molded shape having the outer face constituted by a plurality of faces. In this case, for example, when the work tool or the like comes into contact with the boundary or the like between the adjacent surfaces, stress concentration occurs in the contact portion, and thus the deformation or the like of the accommodating body may occur. However, the accommodating body is stored inside the housing, and thus even though the accommodating body has such a molded shape, the deformation or the like of the accommodating body can be appropriately reduced. Therefore, the temperature sensor can exhibit temperature measurement performance as designed.

### EXPLANATION OF REFERENCE SIGNS

1 temperature sensor
11 thermistor element
12 terminal
13 accommodating body
20 housing
30 resin housing (second housing)
31 insertion portion
34 groove portion
40 metal casing (first housing)
41 small-diameter portion (wall portion)
45 bottom wall (wall portion)
46 concave portion
46a storage space
50 filler

What is claimed is:

1. A temperature sensor comprising: a temperature measuring element; an accommodating body in which the temperature measuring element is embedded and accommodated; and a housing having a storage space in which the accommodating body is stored,
wherein the housing includes a first housing including a concave portion therein that defines the storage space and having outside a temperature measuring surface that comes into contact with an object to be measured, a second housing assembled to the first housing and closing an opening of the concave portion, and a filler with which the storage space is filled and a gap between the accommodating body and the first housing is filled, and
wherein a material constituting the second housing has heat transfer property lower than that of a material constituting the filler.

2. The temperature sensor according to claim 1, further comprising: a terminal connected to the temperature measuring element and extending from the accommodating body, wherein
the terminal is in contact with the filler.

3. The temperature sensor according to claim 2,
wherein the second housing includes an insertion portion that holds the terminal and is inserted into the concave portion to close the opening, and
wherein the insertion portion includes, on an outer face of the insertion portion, a groove portion extending along an insertion direction into the concave portion.

4. The temperature sensor according to claim 1,
wherein the first housing includes a wall portion having one surface which is the temperature measuring surface and other surface which faces the storage space.

5. The temperature sensor according to claim 1,
wherein the accommodating body is a die-molded article having a predetermined molded shape.

6. The temperature sensor according to claim 5,
wherein the molded shape of the accommodating body is a shape having an outer face constituted by a plurality of faces.
